(19) United States
(12) Patent Application Publication
(10) Pub. No.: US 2024/0411270 A1
(43) Pub. Date: Dec. 12, 2024

(54) METHOD FOR MANUFACTURING LUMINOUS HANDS BY REPLICATION OF MICRO-STRUCTURES

(71) Applicant: The Swatch Group Research and Development Ltd, Marin (CH)

(72) Inventor: Cyrille GERNEZ, Boudry (CH)

(73) Assignee: The Swatch Group Research and Development Ltd, Marin (CH)

(21) Appl. No.: 18/645,568

(22) Filed: Apr. 25, 2024

(30) Foreign Application Priority Data
Jun. 12, 2023 (EP) 23178673.2

(51) Int. Cl. G04B 19/32; G04B 19/04

(52) U.S. Cl. CPC G04B 19/32; G04B 19/042

(57) ABSTRACT

A method for manufacturing a luminous horological hand (80), according to which there is separately manufactured, on the one hand, through a first group of operations (1000), at least one light guide (30) or a strip of light guides (35) by replication of micro-structures made initially on a master (1) and, on the other hand, through a second group of operations (2000), at least one hand body (50) or a strip of hand bodies (55), which is assembled with the at least one light guide (30) or a strip of light guides (35) through a bonding operation (600) and an assembly operation (700), before the luminous hand (80) is finished through a final cutting operation (800).

### CROSS REFERENCE TO RELATED APPLICATIONS

This application claims priority to European Patent Application No. 23178673.2 filed Jun. 12, 2023, the entire contents of which are incorporated herein by reference.

### TECHNICAL SCOPE OF THE INVENTION

The invention relates to a method for manufacturing luminous horological hands.

The invention also relates to hands manufactured according to this method.

The invention relates to the manufacture of horological hands, and in particular luminous hands.

### TECHNOLOGICAL BACKGROUND

The documents EP3845974 A1 and WO 2022/122199 A1 describe the principle of operation of fluorescently illuminated hands and methods for manufacturing such hands, the main components of which consist of a sheet metal, a low refractive index layer, the function of which is to optically isolate the metal surface, a medium index layer, the function of which is to guide the fluorescent light towards the edges of the hand, and the deposition of fluorescent pigments which are excited by a remote primary source, for example a LED or the like.

The document WO 2022/122199 A1 describes more particularly a manufacturing method based on the deposition of different resins over a pre-cut sheet metal. This method is difficult to implement, as it proves difficult to hold a liquid resin in an opening, in this case the pre-cut of the metal sheet. The use of a sacrificial film to close the opening around the hand is also particularly delicate. In addition, with such a method, the attachment at the tip of the hand should be cut beyond the resin that forms the light guide, to enable light extraction all around the hand. Hence, the attachment remains visible.

### SUMMARY OF THE INVENTION

The invention aims to develop an industrialisable method for manufacturing luminous hands.

To this end, the invention relates to a method for manufacturing luminous horological hands according to claim 1.

The invention also relates to hands made according to this method.

The invention relates to the field of watch displays, and in particular watch hands, more specifically luminous hands.

### BRIEF DESCRIPTION OF THE FIGURES

The aims, advantages and features will be better understood upon reading the following detailed description and from the appended drawings wherein:

FIGS. 1 to 5 schematically illustrate the steps of the method according to the invention, in several alternative sequences, in which method a first group of operations for manufacturing a light guide and a second group of operations for manufacturing hand bodies are carried out in parallel, before a third group of assembly operations and then a fourth group of finishing operations follow:

FIG. 1 relates to the unitary manufacture of light guides, and the unitary manufacture of hand bodies, and bonding of the hand body during the third group of assembly operations;

FIG. 2 relates to the unitary manufacture of light guides, and the unitary manufacture of hand bodies, and a bonding of the light guide during the third group of assembly operations;

FIG. 3 relates to the manufacture of light guides in strips, and the unitary manufacture of hand bodies, and a bonding of the hand body during the third group of assembly operations;

FIG. 4 relates to the manufacture of light guides in strips, and the unitary manufacture of hand bodies, and a bonding of the hand body during the third group of assembly operations;

FIG. 5 relates to the manufacture of light guides in strips, and the manufacture of hand bodies in strips, and a bonding of the hand body during the third group of assembly operations;

FIGS. 6 and 7 show, in schematic form and in plan view, two examples of luminous hands made according to the invention, coupled with groups of three LEDs each.

### DETAILED DESCRIPTION OF THE INVENTION

The method according to the invention aims to manufacture horological hands, in particular watch hands, the edge of which could be illuminated by optically coupling light into a light guide, so that the hand could be luminous.

In particular, this method is intended to enable monolithic assembly of a hand body, in particular a metal hand body, an optical guide system, means for coupling light into the optical guide and means for diffusing light outside the guide.

In particular, the invention uses the techniques described in EP3845974A1, incorporated herein by reference.

This method is based on the replication of micro-structures.

The method according to the invention is based on the assembly, in particular by bonding, of hand bodies with a light guide cut beforehand. More particularly, the hand bodies are superimposed on this light guide.

The light guide may be in sheet or strip form, and may be used as a transport substrate.

Similarly, a strip of hand bodies may be used as a transport substrate.

The hand bodies may be manufactured in a conventional manner, well-known to a person skilled in the art, and are similar to standard hands.

More particularly, and without limitation, the light guide includes a thin, transparent plastic substrate that is as non-diffusing as possible, over which a resin is deposited and structured. The plastic substrate may be made from different materials, for example and without limitation PET, TAC, PMMA and PC. PET and TAC offer very good optical/mechanical trade-offs.

The method of depositing and structuring the resin over the plastic substrate involves selecting a resin with an index close to that of the plastic sheet. More particularly, and without limitation, the resin is structured by UV-embossing, which could be translated as ultraviolet embossing, to create coupling and light extraction areas.

The adhesive used to assemble the plastic substrate and the hand body should be transparent, non-diffusing and have an optical index lower than that of the substrate.

The method includes different operations, which may differ in chronological order, as described below.

Parallel operations relate to the manufacture of the light guides on the one hand, and the hand bodies on the other hand.

A first group of operations 1000 relates to the manufacture of a light guide: either for the manufacture of unitary light guides 30, or for the manufacture of strips 35 of light guides.

In either case, a first operation 100 involves making a master 1, which is a positive model of a micro-relief to be transferred onto the light guides. More particularly and without limitation, this master 1 is made from a material such as PMMA or the like, which is machined using etching means 110, which may consist of laser etching means, in particular CO₂ laser, picolaser or femtolaser, micro-milling means, or thermal etching means, or the like. The relief of coupling and light extraction micro-structures are created on this master 1, which are then reproduced during a replication process. Thus, different micro-structures are made, some intended to couple/extract light, and others as alignment marks for subsequent manufacturing steps.

A second operation 200 consists in making a negative tool 2, such as a stamp, based on the master 1, in order to print micro-structures; this negative tool 2 may in particular be made of nickel, or silicone, or any suitable material. A plastic substrate 20 is provided, over which a suitable resin is deposited. In particular, yet without limitation, the substrate 20 may be made of PET or TAC, for example, with a thickness of 50 to 100 micrometres. The replication of the micro-structures is achieved by reproducing the micro-structures created on the master 1 on the plastic substrate 20, by means of this resin, under the action of the buffer 2 which allows printing the micro-structures in the resin deposited beforehand over the plastic substrate 20, and thus making at least one raw light guide 30. This replication may be done by UV-embossing, or by hot-embossing, i.e. hot stamping, or any similar method enabling an accurate reproduction of the details of the micro-structures. This replication method may be carried out in a unitary way, in sheets (plate-to-plate or roll-to-plate depending on the manufacturing method), or in strips. The UV-embossing method is particularly effective because of the mechanical possibilities it offers, in particular the possibility of replicating 30 micrometre deep structures. The output of this second operation is either a raw light guide 30 in the case of unitary manufacture, or a strip of light guides 35, including a plurality of raw light guides 30, in the case of strip manufacture.

A third operation 300 relates to the pre-cutting of the light guide: in order to be able to bond a light guide and a hand together, the raw light guide 30 should be cut at the location where the pipe of the hand will be placed. Without this, assembly would not be possible, as the hand pipe would prevent the entire surface of the hand from being brought into contact. This cut is made using cutting means 310, including but not limited to a CO₂ laser, and should be aligned with the different micro-structures present on the raw light guide 30. Preferably, alignment marks have been placed beforehand over the master 1, and reproduced on the raw light guide 30 for this purpose.

In the case of strip manufacture of a strip of light guides 35, it is possible to separate each raw light guide by cutting before, during or after this third cutting operation 300.

In parallel with this first group of operations 1000 relating to the manufacture of a light guide, a second group of operations 2000 includes an operation of manufacturing hand bodies 400, either in a unitary way for the manufacture of a hand body 50, or in strip form according to a standard method with final cutting by stamping. In the case of strip manufacture, the hand bodies 50 may be separated immediately after the hand body manufacturing operation 400, in a separation operation 500 using separation means 510, such as stamping means or other suitable cutting means. In one variant, a strip of hand bodies 55 can be kept until later separation in the process.

A third group of assembly operations 3000 includes a bonding operation 600 for bonding the raw light guide 30, or the strip of light guides 35, and/or the hand body 50, or the strip of hand bodies 55, prior to assembly between the light guide and the hand body. To this end, an adhesive 6 with an optical index lower than that of the light guide is selected, which is deposited over the hand body and/or over the light guide, typically by dispensing means 610.

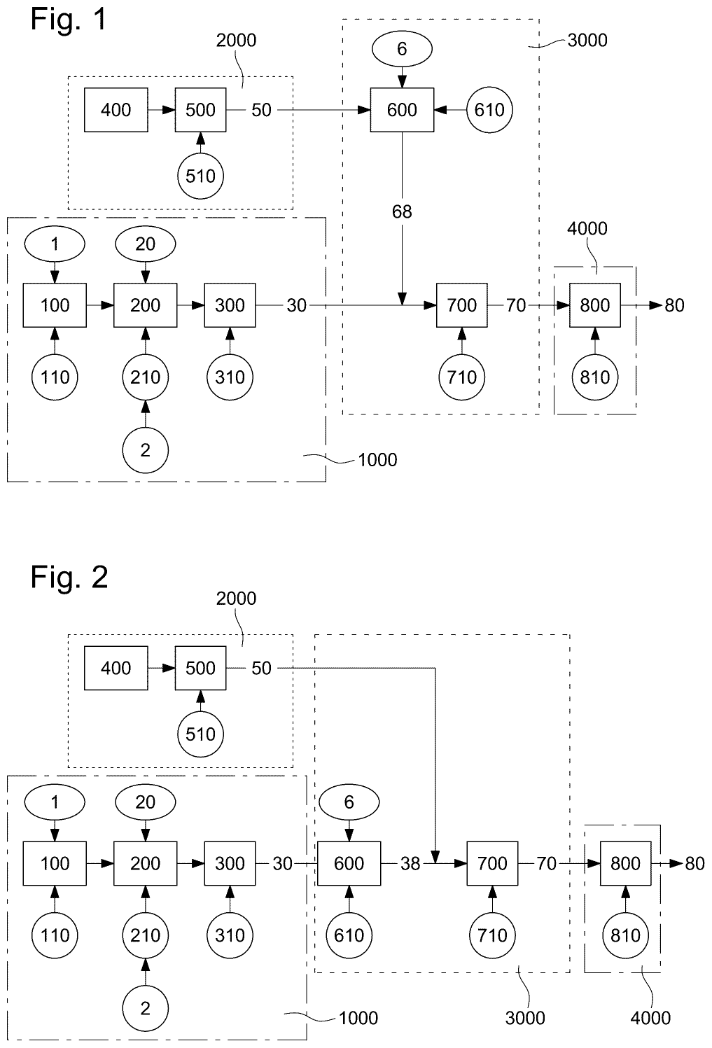

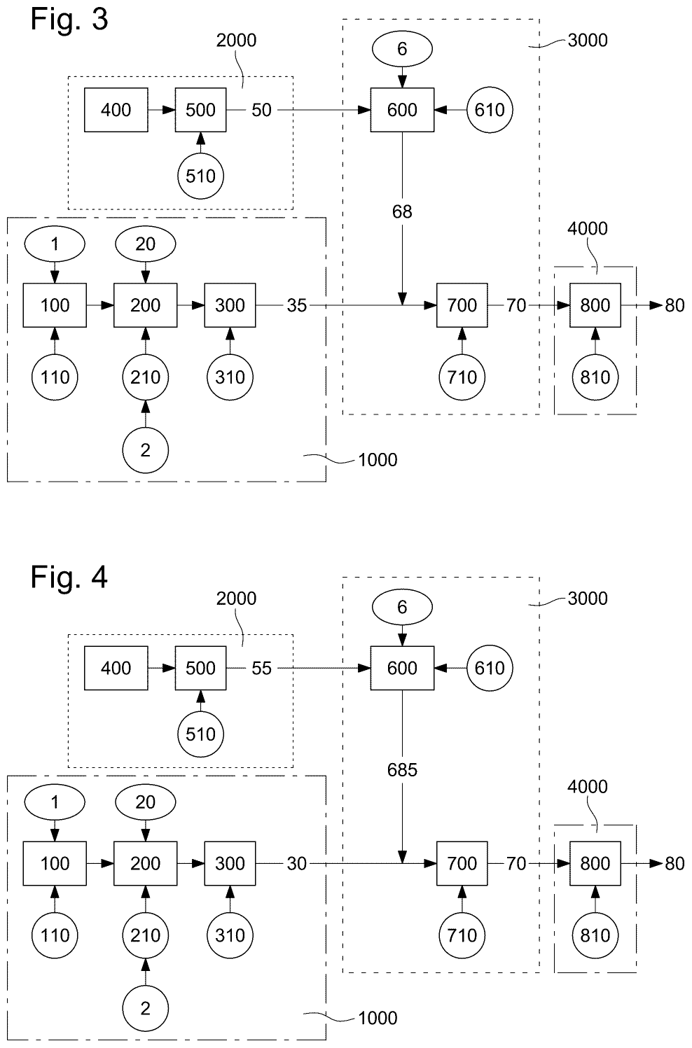

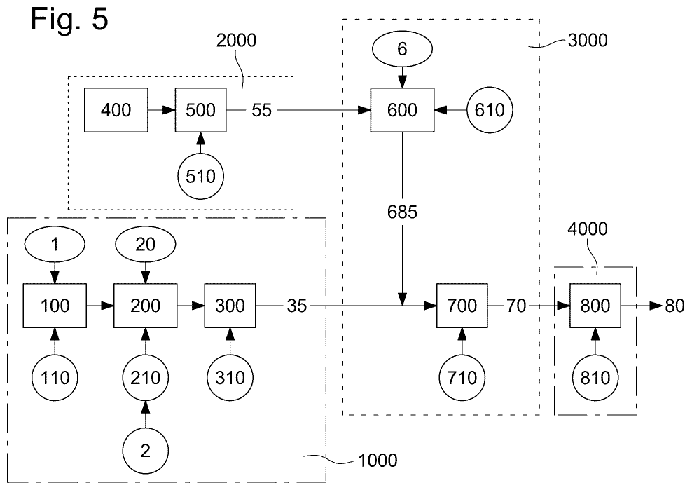

FIGS. 1, 3 to 5 illustrate the case where the bonding is carried out on the hand bodies, unitary 50 in FIGS. 1 and 3, or in hand body strips 55 in FIGS. 4 and 5, the bonded product is then respectively a bonded hand body 68, or a bonded hand body strip 685. FIG. 2 illustrates the case where the light guide is bonded; in this figure it consists of a unitary light guide 30, which becomes a bonded light guide 38 after the bonding operation 600.

This bonding operation 600 is followed, within the time allowed by the properties of the selected adhesive, by an assembly operation 700, during which the hand body is then optically aligned and placed against the light guide, before proceeding with bonding by polymerisation. More particularly, and without limitation, a UV optical adhesive is selected because of its rapid polymerisation. Advantageously, robotic handling means 710 are used, such as a robot coupled to optical recognition means to ensure proper alignment and positioning. At the end of this assembly operation 700, an assembled raw hand 70 is obtained, which remains to be finished.

In the case of strip manufacture, whether a strip of light guides 35 and/or a strip of hand bodies 55, the third group of operations 3000 may be carried out in a similar manner. Nonetheless, the assembly operation 700 is more delicate to implement when assembling a strip of light guides 35 with a strip of hand bodies 55.

A fourth group of operations 4000 includes a final cutting operation 800, the purpose of which is to complete and release each luminous hand 80. In particular, this final cutting operation 800 is carried out by laser cutting means as already mentioned, in particular by femtolaser which gives good results on PET, or cutting by a CO₂ laser, or others.

In the case of unitary manufacture, during this final cutting operation 800, the light guide may finally be cut to release the hand. Preferably, cutting is done approximately 0.1 mm wider than the nominal width of the hand, in order to let the light escape around the hand and towards the wearer of the watch, thanks to the extraction micro-structures provided for this purpose.

The above-described method details the manufacture of hands that will be illuminated over their periphery. It is also possible, in the case of skeleton hands, for the illumination to take place throughout the openings in the hand, or both. The illumination design is not limited to the entire perimeter and, depending on the position of the extractors and the final cut-out, may be only on one side, or only on the tip of the hand, for example.

An alternative method may be implemented, including similar steps, but in a different order. In particular, the method may include pre-cutting the hands into strips. Advantageously, the cut is approximately 0.1 mm narrower than the nominal width of the assembled raw hand 70 in order to let the light escape around the hand towards the wearer of the watch thanks to the extraction micro-structures provided for this purpose. At the same time, the light guide may be manufactured into a strip, in the form of a strip of light guides 35, and the light guide may be cut out/secured. During the operation of assembly of the hand body and the light guide, adhesive with an optical index lower than that of the light guide is deposited over the light guide (alternatively over the hand body), typically by dispensing. Afterwards, the light guide is optically aligned and placed against the hand body to cure the adhesive. During the final cutting operation, the hands are finally cut into strips to release the assembled hand. Advantageously, cutting is done by laser or by stamping.

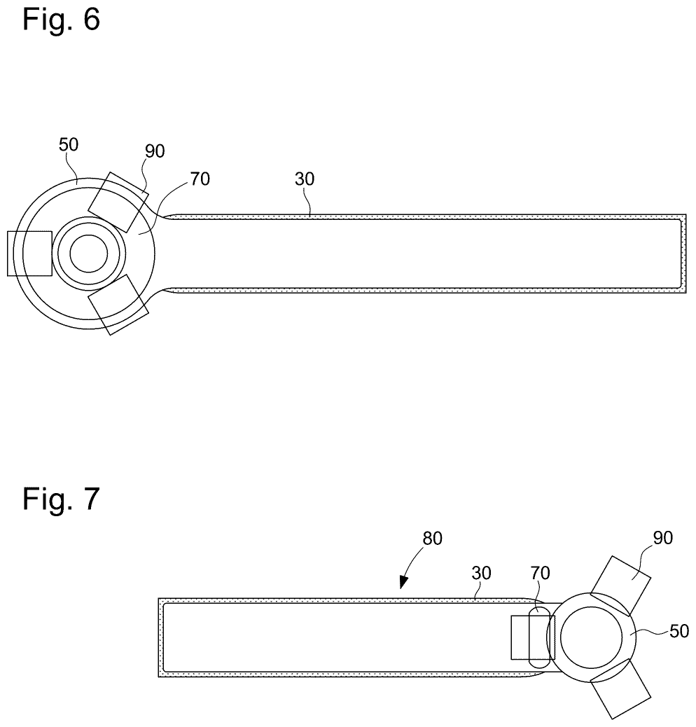

In short, the micro-structures are sufficient to exploit the luminescence which originates from an external light source such as a LED 90, or LEDs 90, whose light “enters” an input light guide 70 of the luminous hand 80 under the hand head and “comes out” at the micro-structures of the light guide 30 which are arranged along the length of the hand. FIGS. 6 and 7 illustrate examples of luminous hands, each of which transmits the light emitted by three LEDs arranged in a triangle, and where a light coupling area relates to the input light guide 70, which is either rotationally symmetrical as in FIG. 6 or punctual as in FIG. 7, a peripheral area is that of the extraction of the light by the micro-structures of the light guide 30 along the entire length of the hand, and at its end, projecting slightly with respect to the hand body 50. This allows ensuring continuity of light, even though some of the light extraction structures are cut out or removed, depending on the accuracy of the cutting alignment.

With regards to materials, the light guide is advantageously a combination of a plastic substrate 20 (support) with a resin in which the different micro-structures are printed, in particular by the preferred UV-embossing method, which gives very good results, although hot-embossing of the micro-structures directly into the substrate 20 may also be considered.

Both the substrate and the resin must be as transparent as possible to avoid light losses. The choice of using “clear” materials is advantageous because they are accessible in the desired thicknesses. In principle, coloured materials (for example fluorescent) could be considered while remaining transparent. However, it is essential that the refractive indices of the two materials are as close as possible. The refractive index of the adhesive that assembles the guide to the hand must be as low as possible compared to that of the substrate, to optically isolate the guide. It is not necessary to insert particles of any kind into the light guide.

1. A method for manufacturing a luminous horological hand (80), comprising separately manufacturing, on the one hand, through a first group of operations (1000), at least one light guide (30) or a strip of light guides (35) by replication of micro-structures made initially on a master (1) and, on the other hand, through a second group of operations (2000), at least one hand body (50) or a strip of hand bodies (55), which are assembled with said at least one light guide (30) or said strip of light guides (35) through a bonding operation (600) and an assembly operation (700), before said luminous hand (80) is finished through a final cutting operation (800).

2. The method according to claim 1, wherein, in said first group of operations (1000), in a first operation (100) said master (1), which is a positive model of a micro-relief to be transferred onto said at least one light guide (30) or said strip of light guides (35), is made with etching means (110), said micro-relief including micro-structures, some provided for the coupling and extraction of the light, and others as alignment marks for other manufacturing steps.

3. The method according to claim 2, wherein, in said first group of operations (1000), in a second operation (200), a negative tool (2) is made based on said master (1), in order to print micro-structures, a substrate (20) made of plastic is provided, over which a resin is deposited, and microstructures are replicated by reproducing the microstructures created on said master (1) on said plastic substrate (20), by means of said resin, under the action of said negative tool (2) which allows printing said microstructures in said resin deposited beforehand over said plastic substrate (20) in order to make at least one raw light guide (30) or a strip of light guides (35).

4. The method according to claim 3, wherein said substrate (20) is selected from PET or TAC, with a thickness of 50 to 100 micrometres.

5. The method according to claim 3, wherein said replication of said micro-structures is performed by UV-embossing or by hot-embossing.

6. The method according to claim 3, wherein after said second operation (200), in a third operation (300) the raw light guide is pre-cut at the location where the pipe of the hand should be placed, using cutting means (310) or a CO₂ laser, and aligned with said alignment marks present on the raw light guide.

7. The method according to claim 1, wherein during said final cutting operation (800), each said luminous hand (80) is finished and released, using laser cutting means, and the cut is made approximately 0.1 mm wider than the nominal width of the hand, in order to let the light escape around the hand and towards the wearer of the watch, thanks to said extraction micro-structures provided for this purpose.

8. The method according to claim 1, wherein said method is implemented for the manufacture of a hand to be illuminated on its periphery, onto which said micro-structures are replicated.

9. The method according to claim 1, wherein said method is implemented for the manufacture of a skeleton hand to be illuminated at least throughout the openings of said hand.

10. The method according to claim 1, wherein said method is implemented for the manufacture of a hand to be illuminated only on one side, or only on the tip of the hand.
